(19) United States
(12) Patent Application Publication
(10) Pub. No.: US 2026/0063439 A1
(43) Pub. Date: Mar. 5, 2026

(54) METHODS FOR PRESENTING ROUTE GUIDANCE AT AN AUGMENTED REALITY HEADSET AND DEVICES AND SYSTEMS THEREOF

(71) Applicant: Meta Platforms Technologies, LLC, Menlo Park, CA (US)

(72) Inventors: Ata Dogan, Seattle, WA (US); Dominic Vincent Aratari, Holly Springs, NC (US); Tung Him Karpenko, Alhambra, CA (US)

(21) Appl. No.: 19/315,353

(22) Filed: Aug. 29, 2025

Related U.S. Application Data
(60) Provisional application No. 63/690,251, filed on Sep. 3, 2024.

(51) Int. Cl. G01C 21/36

(52) U.S. Cl. CPC G01C 21/3638; G01C 21/362; G01C 21/3632; G01C 21/3644

(57) ABSTRACT

An example method includes, displaying, at an augmented-reality (AR) display of an AR headset, a map extended-reality (XR) augment that includes a first set of XR landmarks. The AR headset has a first orientation in the physical environment, and the first set of XR landmarks are presented to a wearer such that the first set of XR landmarks overlays the corresponding first set of physical landmarks of the physical environment seen through the AR display. The method includes that in response to detecting a change in orientation of the AR headset to a second orientation in the physical environment, displaying the map XR augment to include a second set of XR landmarks. The second set of XR landmarks are presented to the wearer such that the second set of XR landmarks overlays the corresponding second set physical landmarks of the physical environment seen through the AR display.

### RELATED APPLICATION

This application claims priority to U.S. Provisional Application Ser. No. 63/690,251, filed Sep. 3, 2024, entitled “Methods For Presenting Route Guidance At An Augmented Reality Headset And Devices And Systems Thereof”, which is incorporated herein by reference.

### TECHNICAL FIELD

This relates generally to presenting a maps navigation extended-reality (XR) augment for presentation at an AR headset (e.g., a pair of augmented reality (AR) glasses).

### BACKGROUND

While maps applications on mobile devices such as mobile phones and vehicles are well known in the industry and provide directions to users during use, they require users to look elsewhere or distract them from where they are intending to go. This can be problematic in situations where focus is needed such as navigating a busy intersection on foot or driving a vehicle.

Further, present systems, devices, and techniques for providing navigational assistance to a user are based on presenting the information at a two-dimensional display, particularly since audio-only user interfaces are typically not sufficient for providing all of the necessary details for guiding a user along a route. Thus, the two-dimensional displays are distracting, and thereby can be dangerous in certain situations (e.g., when the user is driving).

As such, there is a need to address one or more of the above-identified challenges. A brief summary of solutions to the issues noted above are described below.

### SUMMARY

Accordingly, displaying an map augment at a display of an augmented-reality headset alleviates the issue noted above. Providing a map augment at an augmented-reality headset allows for route guidance to be provided in the line of sight of the user which makes presentation more efficient. In this case, the user need not look elsewhere for the directions as the directions will always be visible and oriented based on their surroundings and orientation.

The present application conveys many technical improvements to current systems, some of which will be explicitly described here. One example of improvement achieved by the present application is that a user can more efficiently and effectively receive route guidance at an augmented reality headset as opposed to a cellphone device, in accordance with some embodiments. Unlike with a cellphone device, the user of an AR headset need not look down at the device and have to reorient themselves each time they look up to view their environment. Having the route guidance overlaying the corresponding physical environment in the wearer's field of view allows the route guidance to be in the most convenient location possible and does not disorient the wearer. Further the navigational assistance described herein can be provided in a manner in which the user is able to keep their hands free, as opposed to having to hold a mobile device.

The present application further describes systems, devices, and techniques for accessing and managing route guidance quickly and efficiently, and particularly using an input combination that includes EMG, always available display on the augmented-reality headset, and artificially intelligent assistant. For example, an artificially intelligent system could automatically without human intervention initiate route guidance based on viewing the path the user is taking, seeing a location or address a user has physically viewed, etc.

The present application further describes systems where the viewing of a particular map is both natural and spatial, meaning that as the wearer moves the map, information is updated in real time to move with the wearer. In addition, the wearer can also be presented with audio directions using spatial audio so the directions are heard coming from the location in which the directions are guiding them (e.g., “turn left” will be perceived by the wearer as emanating from the left of them (e.g., the user can follow an audio note to get to their location).

The present application further describes embodiments where the wearer can invoke navigational assistance based on proactive notifications (e.g., a notification invoked by an artificially intelligent assistant capable of discerning whether guidance should be provided (e.g., the user is looking at street signs or viewing an address (e.g., town hall meeting at community center))).

An example embodiment includes a method that comprises displaying, at an augmented-reality (AR) display of an AR headset, a map augment that includes a first set of AR landmarks (e.g., AR buildings, AR streets, AR signs/signals, AR statues, etc.). The AR headset has a first orientation in the physical environment, and the first set of AR landmarks are configured to be presented to a wearer of the AR headset such that the first set of AR landmarks overlays the corresponding first set of physical landmarks of the physical environment seen through the AR display (e.g., the AR landmarks may appear as opaque reconstructions laid on top of corresponding physical landmarks). In some embodiments, the AR landmarks can have less detail than the corresponding physical landmarks (e.g., smoothed surfaces, intricate detail removed etc.). The method also includes that in response to detecting a change in orientation of the AR headset (e.g., the AR headset can include multiple inertial measurement units (IMUs) that can provide data for determining changes in orientation of the AR headset) to a second orientation in the physical environment different from the first orientation, displaying the map augment to include a second set of AR landmarks. The second set of AR landmarks are configured to be presented to the wearer of the AR headset such that the second set of AR landmarks overlays the corresponding second set physical landmarks of the physical environment seen through the AR display, and the second set of AR landmarks is different from the first set of AR landmarks. For example, FIG. 3 in second pane 302 that as the user moves the map is updated based on the movement of AR headset relative to the surrounding physical environment.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset (e.g., a mixed-reality (MR) headset or an augmented-reality (AR) headset as two examples), a wrist-wearable device, an intermediary processing device, a smart textile-based garment, etc. For instance, the instructions can be stored on an AR headset or can be stored on a combination of an AR headset and an associated input device (e.g., a wrist-wearable device) such that instructions for causing detection of input operations can be performed at the input device and instructions for causing changes to a displayed user interface in response to those input operations can be performed at the AR headset. The devices and systems described herein can be configured to be used in conjunction with methods and operations for providing an XR experience. The methods and operations for providing an XR experience can be stored on a non-transitory computer-readable storage medium.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an augmented-reality headset that displays route guidance on at least one lens assembly that, in some embodiments, includes a waveguide, in accordance with some embodiments.

FIGS. 2A to 2E illustrate various interactions with route guidance user interfaces presented at AR headsets, in accordance with some embodiments.

FIG. 3 illustrates how a route guidance can be initiated from applications integrated with the operating system of a mobile device, such as native messaging and maps applications, in accordance with some embodiments.

FIG. 4 illustrates a plurality of augments that can be displayed at an augmented-reality headset 100, in accordance with some embodiments.

FIG. 5 shows an example method flow chart for displaying, at an augmented-reality (AR) display of an AR headset, a map augment, in accordance with some embodiments.

FIGS. 6A, 6B, and 6C-1, and 6C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR headset. Throughout this application, the term “extended reality (XR)” is used as a catchall term to cover both ARs and MRs. In addition, this application also uses, at times, a head-wearable device or headset device as a catchall term that covers XR headsets such as AR headsets and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiogramar EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

Interacting with Map XR Augments

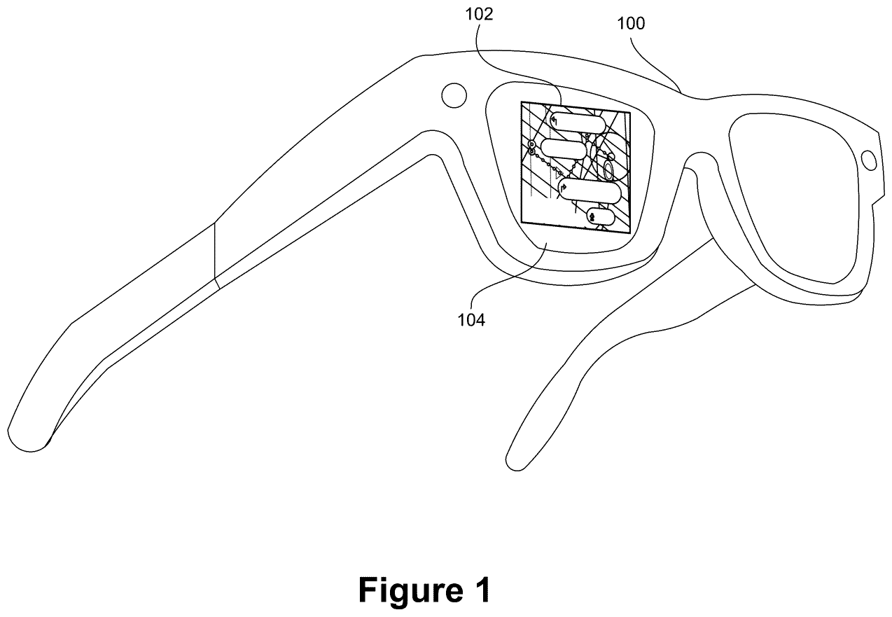

FIG. 1 illustrates an augmented-reality headset 100 that displays route guidance 102 on at least one lens assembly 104 that, in some embodiments, includes a waveguide, in accordance with some embodiments. In some embodiments, the route guidance 102, is presented to a wearer having a perspective view that can be presented such that it overlays the environment the user is viewing (e.g., streets shown in route guidance 102 overlay the corresponding street in the physical environment). In some embodiments, the route guidance is displayed at only one of the lenses of the augmented-reality headset. In other embodiments the route guidance is displayed binocularly at both lenses of the augmented-reality headset.

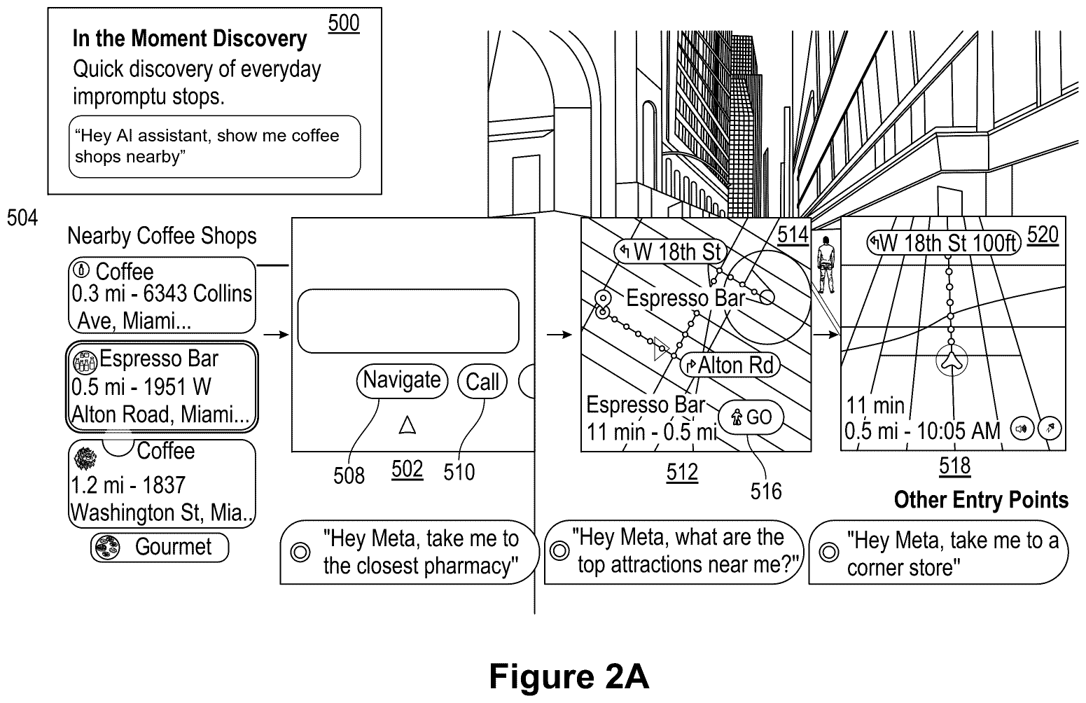

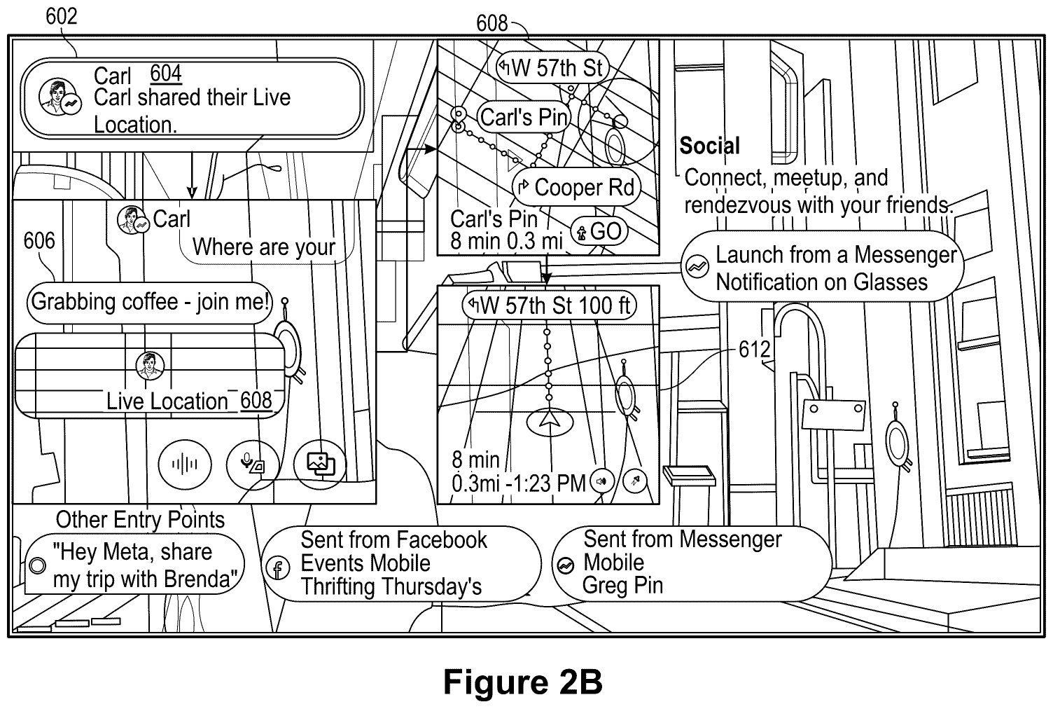

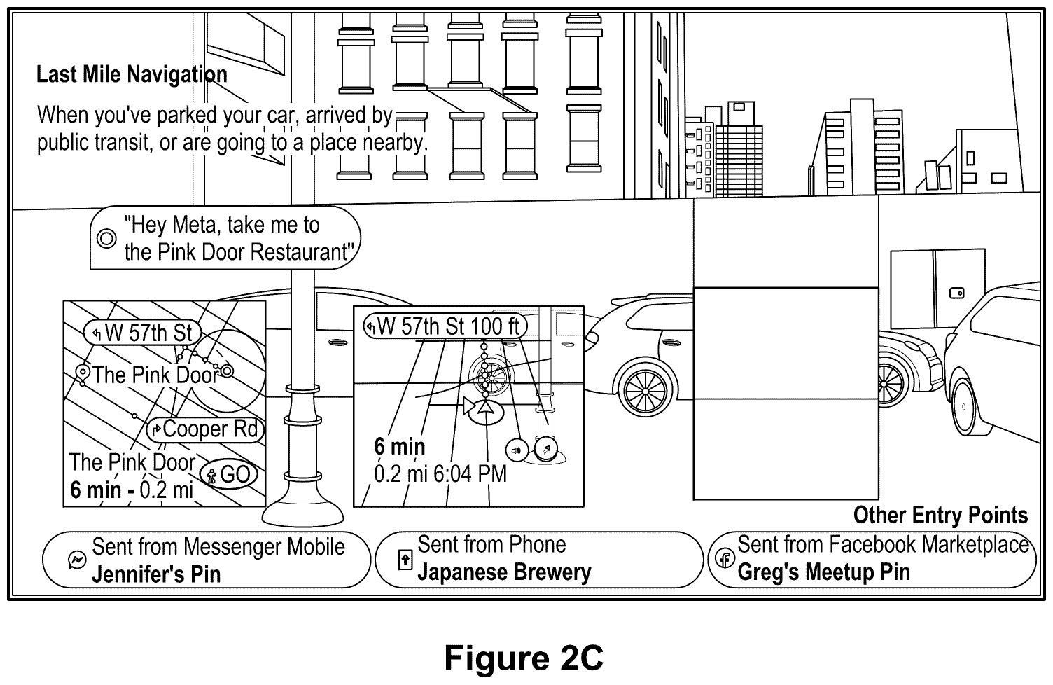

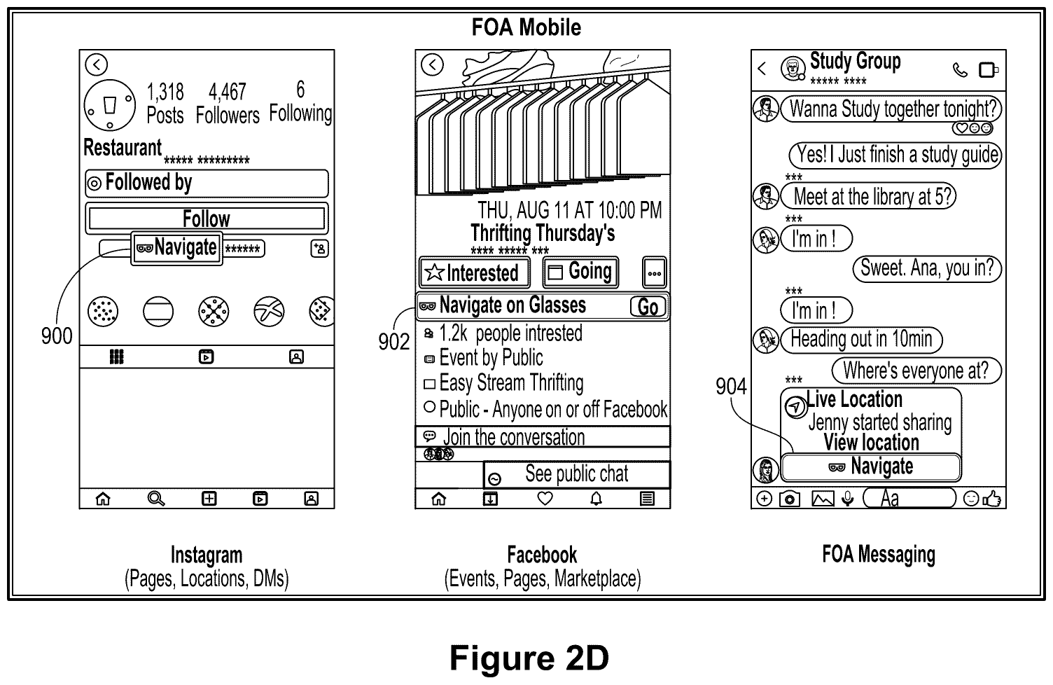

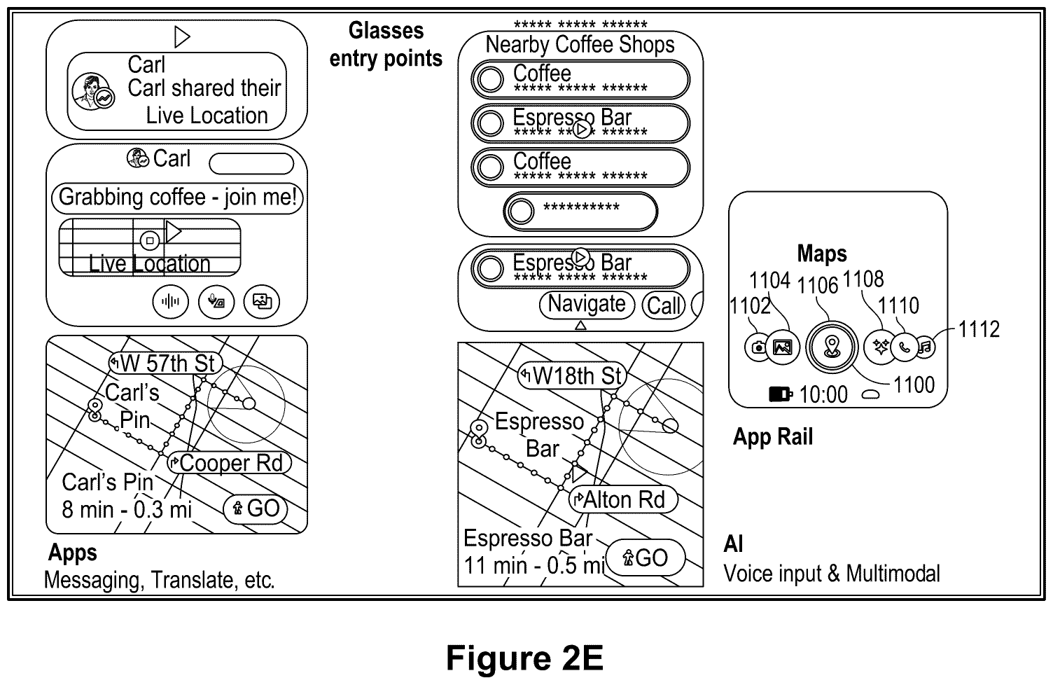

FIGS. 2A to 2E illustrate various interactions with route guidance user interfaces presented at AR headsets, in accordance with some embodiments.

FIG. 2A shows an interaction in which directions are invoked after a user queries an artificially intelligent (AI) virtual assistant, in accordance with some embodiments. As is shown in a first pane 500, a user makes a query of an AI virtual assistant (e.g., a voice command stating “Hey AI assistant, show me coffee shops nearby”). In response, an augment 502 (e.g., a user interface that is displayed in front of a user's environment) is populated with results based on the user's query (e.g., four different coffee shops). This augment 502 is presented at augmented-reality headset 100.

As shown in second pane 504, a user interface 506 is provided in response to a selection of one of the results presented in first pane 500. The user interface 506 includes additional user augments for performing operations related to the selected result (e.g., navigate augment 508 for navigating to the selected location, a call augment 510 for calling the selected location, etc.). A third pane 512 shows that in response to a selection of a navigate augment 508, a map route guidance overview augment 514 is displayed that includes an augment 516 for starting route guidance. A fourth pane 518 shows that in response to a selection of the augment 516, route guidance is initiated, and a route guidance augment 520 is displayed.

FIG. 2B shows another point in the sequence illustrated by FIGS. 2A to 2[X], and illustrates an example in which route guidance can be invoked in response to an individual sharing their current location, in accordance with some embodiments. FIG. 2B shows in a first pane 602 that an individual shared their location with the user associated with augmented-reality headset 100. In response, an augment 604 is displayed, notifying the user that the location has been shared with them. A second pane 606 shows that at a later time the user that shared their location sends a message to the wearer of the augmented-reality headset 100. In some instances, if another user has previously shared their location with the wearer of the augmented-reality headset 100, an augment 608 is displayed (e.g., automatically) that shows the location of the other user. A third pane 610 shows that in response to selecting the augment 608, route guidance is initiated. A fourth pane 612 shows an AR augment that shows the route guidance in progress and being displayed over the corresponding environment.

FIG. 2C shows an instance in which route guidance is provided to the wearer once it is detected that the user is in their final stretch to their destination, in accordance with some embodiments. For example, the augmented-reality headset 100 can detect that the user has left their car and is finishing the remainder of their trip on foot. In response, the augmented-reality headset 100 can automatically present the walking directions to the destination. In some embodiments, the user can query the AI virtual assistant for directions, and as is shown here the query need not be specific. For example, the query could be completed by just reciting known features of the location (e.g., the pink door restaurant, the place that sells artisanal muffins, etc.).

FIG. 2D illustrates a way of initiating route guidance on a augmented-reality headset 100 from another device (e.g., a mobile phone device), in accordance with some embodiments. FIG. 2D shows three different example avenues in which route guidance can be sent from another device to a augmented-reality headset 100. In a first example, a social media application can include a user interface element 900 for invoking route guidance to the location associated with the social media page (e.g., a restaurant social media page). In some embodiments, the location may be included on the social media page and selecting the address can invoke route guidance on the augmented-reality headset 100 (e.g., if the other device is in communication with augmented-reality headset 100 and it is determined that it is being worn). A second example of this can be shown in user interface 902, in which a user can navigate to a social gathering.

FIG. 2D illustrates another instance in which route guidance can be invoked from another device. In the example shown in user interface 904, a user interface element to invoke route guidance can be provided in a messaging conversation when a location is provided (e.g., another user's location or a location provided in the conversation).

FIG. 2E illustrates some other avenues in which the route guidance or a map can be invoked on augmented-reality headset 100, in accordance with some embodiments. FIG. 2E also shows an application rail 1100 that is displayed at augmented-reality headset 100, and in some instances the application rail can include an icon 1102 for invoking a camera application of the augmented-reality headset 100 (or camera of another device), an icon 1104 for invoking a photos application, an icon 1106 for invoking a maps application, an icon 1108 for invoking an AI digital assistant, an icon 1110 for invoking a phone application, an icon 1112 for invoking for invoking a music application, a translate application, etc.

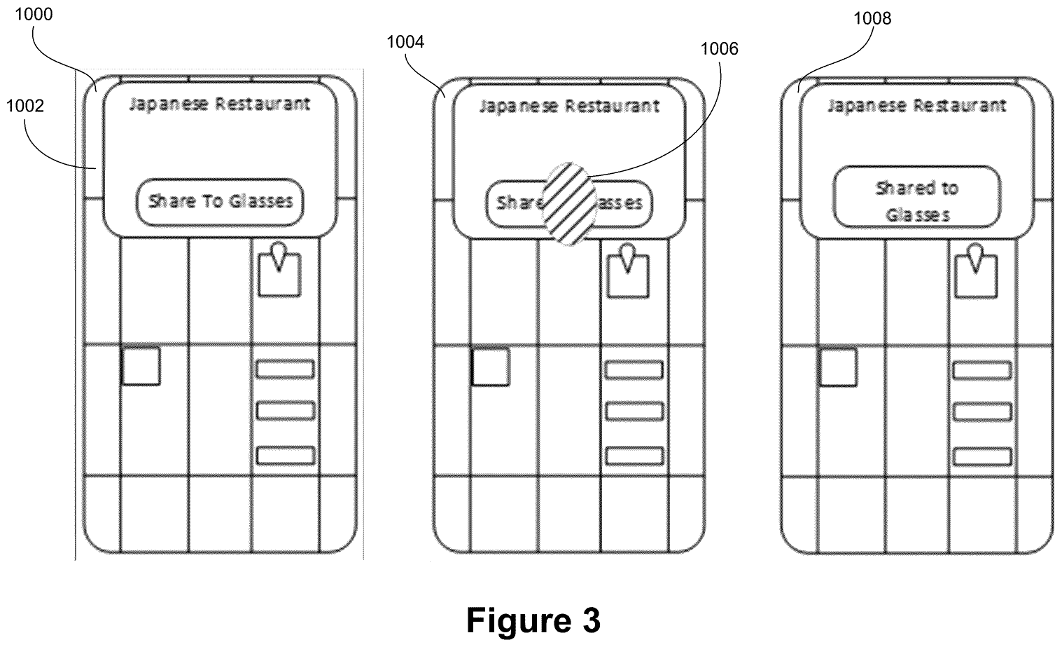

FIG. 3 illustrates how a route guidance can be initiated from applications integrated with the operating system of a mobile device, such as native messaging and maps applications, in accordance with some embodiments. FIG. 10 shows a user interface 1000 that shows a user interface element 1002 for sharing route guidance, and user interface 1004 shows an input 1006 being received at the user interface element. Lastly, user interface 1008 notifies the user that the route guidance has been shared with augmented-reality headset 100.

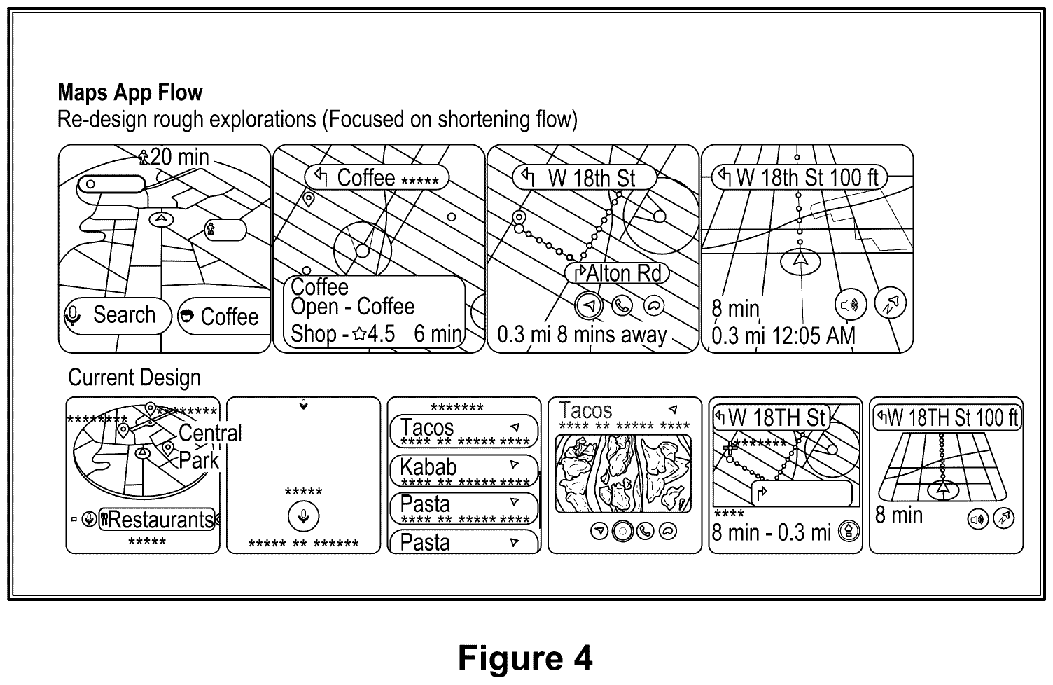

FIG. 4 illustrates a plurality of augments that can be displayed at an augmented-reality headset 100, in accordance with some embodiments.

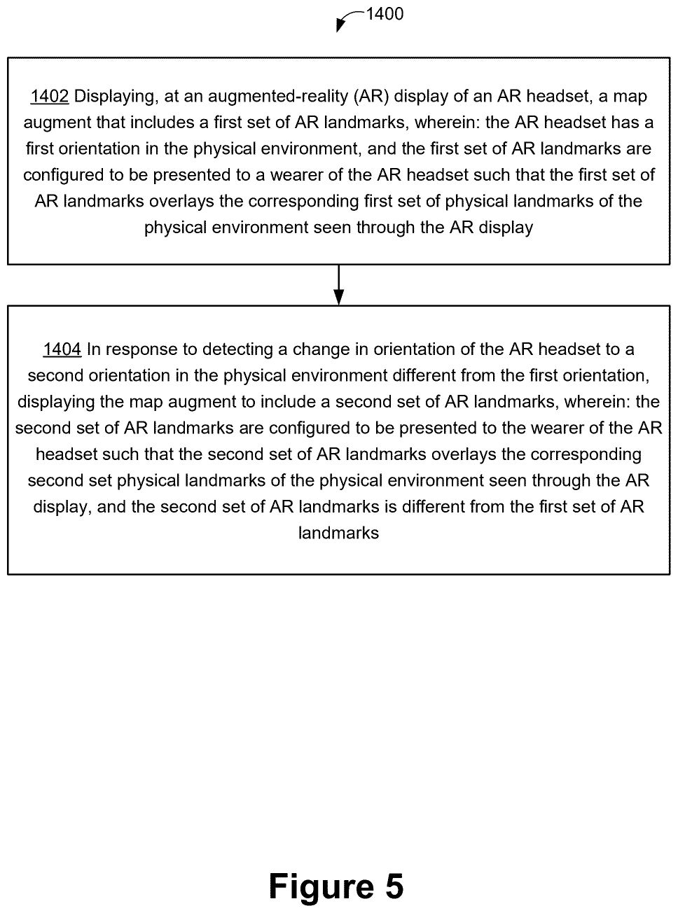

FIG. 5 illustrates a flow diagram of a method of displaying, at an augmented-reality (AR) display of an AR headset, a map augment, in accordance with some embodiments. Operations of the method 1400 can be performed by a single device alone or in conjunction with one or more processors and/or hardware components of another communicatively coupled device (e.g., an augmented-reality headset) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

(A1) In accordance with some embodiments, a method comprises displaying (1402), at an augmented-reality (AR) display of an AR headset, a map augment that includes a first set of AR landmarks (e.g., AR buildings, AR streets, AR signs/signals, AR statues, etc.). The AR headset has a first orientation in the physical environment, and the first set of AR landmarks are configured to be presented to a wearer of the AR headset such that the first set of AR landmarks overlays the corresponding first set of physical landmarks of the physical environment seen through the AR display (e.g., the AR landmarks may appear as opaque reconstructions laid on top of corresponding physical landmarks). In some embodiments, the AR landmarks can have less detail than the corresponding physical landmarks (e.g., smoothed surfaces, intricate detail removed etc.). The method also includes that in response to detecting a change in orientation of the AR headset (e.g., the AR headset can include multiple inertial measurement units (IMUs) that can provide data for determining changes in orientation of the AR headset) to a second orientation in the physical environment different from the first orientation, displaying (1404) the map augment to include a second set of AR landmarks. The second set of AR landmarks are configured to be presented to the wearer of the AR headset such that the second set of AR landmarks overlays the corresponding second set physical landmarks of the physical environment seen through the AR display, and the second set of AR landmarks is different from the first set of AR landmarks.

(A2) In some embodiments of A1, the map augment includes a AR route augment that is configured to be presented to a wearer of the AR headset such that the AR route augment overlays the corresponding route of the physical environment seen through the AR display.

(A3) In some embodiments of A2, the route augment is walking route guidance or driving route guidance. For example, FIG. 2A shows initiating walking directions at the AR headset.

(A4) In some embodiments of any of A1-A3, the first set of AR landmarks are visually different than the corresponding first set of physical landmarks in the physical environment.

(A5) In some embodiments of any of A1-A4, the augmented-reality (AR) display corresponds to a single eye of the user. For example, FIG. 1 shows the route guidance 102 being displayed at a single side of the AR headset 100.

In some embodiments, the navigational and/or directional assistance tools described herein can be initiated via EMG based controls. As mentioned earlier, the directions can be enhanced via AI, by using natural voice-based interactions with AI, which provides a wide range of navigational intents & discovery (specific places or broader categories).

In some embodiments, the navigations and/or directional assistance tools described herein can be invoked from a plurality of different applications. For example, navigation can be invoked from a messaging application, a social media application. In addition, a user can share locations from other mobile apps like a map application. In some embodiments, the applications are running on other devices in communication with the head-wearable device (e.g., a user selects an address in a messaging conversation and direction are provided to the head-wearable device).

Some embodiments herein describe interactions in which a user can quickly localize themselves with context from a map application being shown on a augmented-reality headset. For example, the user may initiate the maps application from an application rail displayed at the AR headset and controlled using either audio commands or hand gestures detected from an electromyography sensor integrated into a wrist-wearable device.

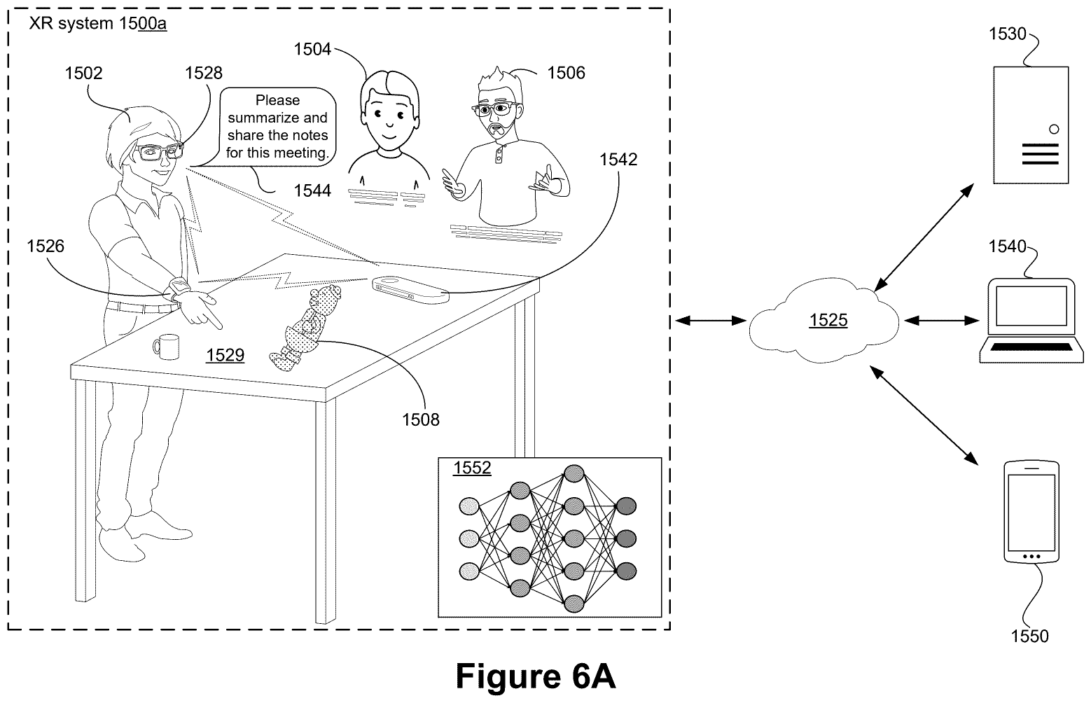

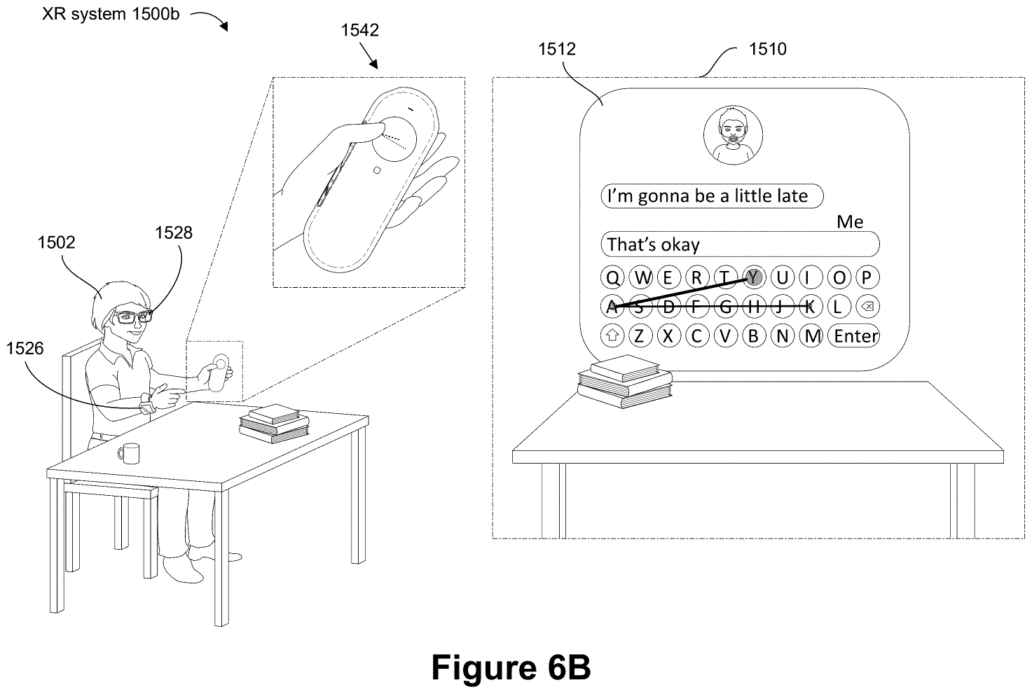

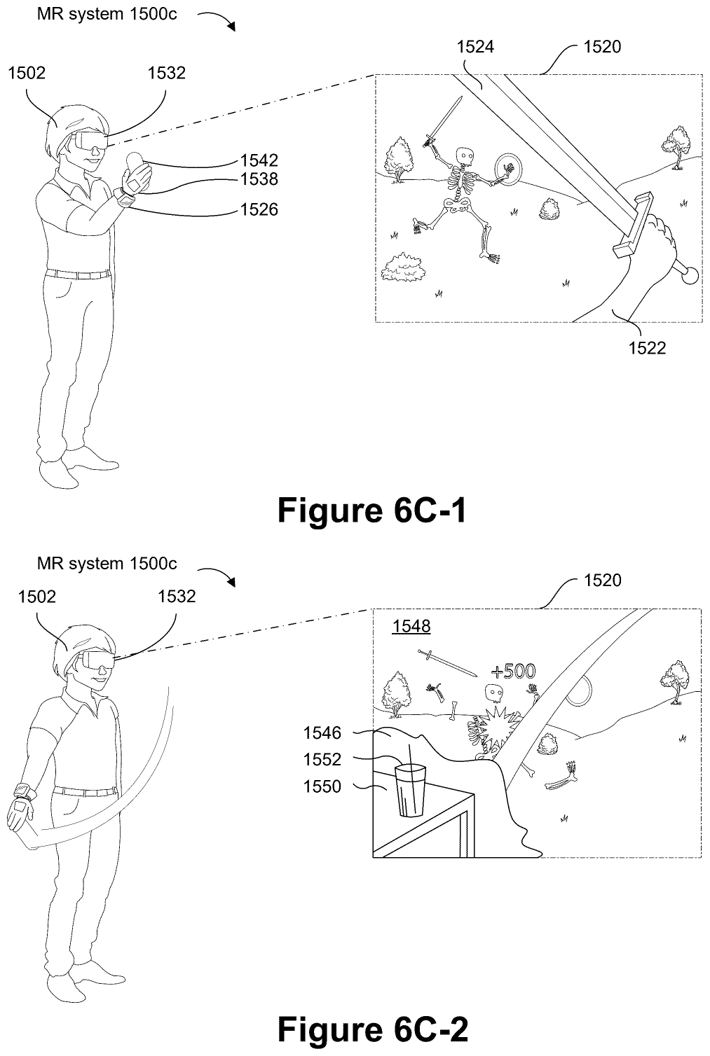

(B1) In accordance with some embodiments, a method comprises receiving information from an application of on an augmented-reality (AR) headset. The method includes that in accordance with a determination that the information is associated with a location, displaying an augment for invoking an AR navigation application of the AR headset to navigate the location. The method also includes receiving an interaction at the augment and in response to receiving the interaction, displaying at an AR display of an augmented-reality an AR interface that includes: (i) a route overview augment that shows a route to the location, and an augment for initiating route guidance. For example, FIG. 6 shows an interaction in which route guidance can be invoked in response to an individual sharing their current location.

(B2) In some embodiments of B1, the method includes receiving an interaction at the AR augment for initiating route guidance, and in response to receiving the interaction at the AR augment for initiating route guidance, displaying a perspective route AR augment for providing turn-by-turn navigation to the location.

(B3) In some embodiments of any of B1-B2, the application is different from the AR navigation application.

### Example Extended-Reality Systems

FIGS. 6A, 6B, 6C-1, and 6C-2 illustrate example XR systems that include AR and MR systems, in accordance with some embodiments. FIG. 6A shows a first XR system 1500a and first example user interactions using a wrist-wearable device 1526, a head-wearable device (e.g., AR device 1528), and/or a HIPD 1542. FIG. 6B shows a second XR system 1500b and second example user interactions using a wrist-wearable device 1526, AR device 1528, and/or an HIPD 1542. FIGS. 6C-1 and 6C-2 show a third MR system 1500c and third example user interactions using a wrist-wearable device 1526, a head-wearable device (e.g., an MR device such as a VR device), and/or an HIPD 1542. As the skilled artisan will appreciate upon reading the descriptions provided herein, the above-example AR and MR systems (described in detail below) can perform various functions and/or operations.

The wrist-wearable device 1526, the head-wearable devices, and/or the HIPD 1542 can communicatively couple via a network 1525 (e.g., cellular, near field, Wi-Fi, personal area network, wireless LAN). Additionally, the wrist-wearable device 1526, the head-wearable device, and/or the HIPD 1542 can also communicatively couple with one or more servers 1530, computers 1540 (e.g., laptops, computers), mobile devices 1550 (e.g., smartphones, tablets), and/or other electronic devices via the network 1525 (e.g., cellular, near field, Wi-Fi, personal area network, wireless LAN). Similarly, a smart textile-based garment, when used, can also communicatively couple with the wrist-wearable device 1526, the head-wearable device(s), the HIPD 1542, the one or more servers 1530, the computers 1540, the mobile devices 1550, and/or other electronic devices via the network 1525 to provide inputs.

Turning to FIG. 6A, a user 1502 is shown wearing the wrist-wearable device 1526 and the AR device 1528 and having the HIPD 1542 on their desk. The wrist-wearable device 1526, the AR device 1528, and the HIPD 1542 facilitate user interaction with an AR environment. In particular, as shown by the first AR system 1500a, the wrist-wearable device 1526, the AR device 1528, and/or the HIPD 1542 cause presentation of one or more avatars 1504, digital representations of contacts 1506, and virtual objects 1508. As discussed below, the user 1502 can interact with the one or more avatars 1504, digital representations of the contacts 1506, and virtual objects 1508 via the wrist-wearable device 1526, the AR device 1528, and/or the HIPD 1542. In addition, the user 1502 is also able to directly view physical objects in the environment, such as a physical table 1529, through transparent lens(es) and waveguide(s) of the AR device 1528. Alternatively, an MR device could be used in place of the AR device 1528 and a similar user experience can take place, but the user would not be directly viewing physical objects in the environment, such as table 1529, and would instead be presented with a virtual reconstruction of the table 1529 produced from one or more sensors of the MR device (e.g., an outward facing camera capable of recording the surrounding environment).

The user 1502 can use any of the wrist-wearable device 1526, the AR device 1528 (e.g., through physical inputs at the AR device and/or built-in motion tracking of a user's extremities), a smart-textile garment, externally mounted extremity tracking device, the HIPD 1542 to provide user inputs, etc. For example, the user 1502 can perform one or more hand gestures that are detected by the wrist-wearable device 1526 (e.g., using one or more EMG sensors and/or IMUs built into the wrist-wearable device) and/or AR device 1528 (e.g., using one or more image sensors or cameras) to provide a user input. Alternatively, or additionally, the user 1502 can provide a user input via one or more touch surfaces of the wrist-wearable device 1526, the AR device 1528, and/or the HIPD 1542, and/or voice commands captured by a microphone of the wrist-wearable device 1526, the AR device 1528, and/or the HIPD 1542. The wrist-wearable device 1526, the AR device 1528, and/or the HIPD 1542 include an artificially intelligent digital assistant to help the user in providing a user input (e.g., completing a sequence of operations, suggesting different operations or commands, providing reminders, confirming a command). For example, the digital assistant can be invoked through an input occurring at the AR device 1528 (e.g., via an input at a temple arm of the AR device 1528). In some embodiments, the user 1502 can provide a user input via one or more facial gestures and/or facial expressions. For example, cameras of the wrist-wearable device 1526, the AR device 1528, and/or the HIPD 1542 can track the user 1502's eyes for navigating a user interface.

The wrist-wearable device 1526, the AR device 1528, and/or the HIPD 1542 can operate alone or in conjunction to allow the user 1502 to interact with the AR environment. In some embodiments, the HIPD 1542 is configured to operate as a central hub or control center for the wrist-wearable device 1526, the AR device 1528, and/or another communicatively coupled device. For example, the user 1502 can provide an input to interact with the AR environment at any of the wrist-wearable device 1526, the AR device 1528, and/or the HIPD 1542, and the HIPD 1542 can identify one or more back-end and front-end tasks to cause the performance of the requested interaction and distribute instructions to cause the performance of the one or more back-end and front-end tasks at the wrist-wearable device 1526, the AR device 1528, and/or the HIPD 1542. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 1542 can perform the back-end tasks and provide the wrist-wearable device 1526 and/or the AR device 1528 operational data corresponding to the performed back-end tasks such that the wrist-wearable device 1526 and/or the AR device 1528 can perform the front-end tasks. In this way, the HIPD 1542, which has more computational resources and greater thermal headroom than the wrist-wearable device 1526 and/or the AR device 1528, performs computationally intensive tasks and reduces the computer resource utilization and/or power usage of the wrist-wearable device 1526 and/or the AR device 1528.

In the example shown by the first AR system 1500a, the HIPD 1542 identifies one or more back-end tasks and front-end tasks associated with a user request to initiate an AR video call with one or more other users (represented by the avatar 1504 and the digital representation of the contact 1506) and distributes instructions to cause the performance of the one or more back-end tasks and front-end tasks. In particular, the HIPD 1542 performs back-end tasks for processing and/or rendering image data (and other data) associated with the AR video call and provides operational data associated with the performed back-end tasks to the AR device 1528 such that the AR device 1528 performs front-end tasks for presenting the AR video call (e.g., presenting the avatar 1504 and the digital representation of the contact 1506).

In some embodiments, the HIPD 1542 can operate as a focal or anchor point for causing the presentation of information. This allows the user 1502 to be generally aware of where information is presented. For example, as shown in the first AR system 1500a, the avatar 1504 and the digital representation of the contact 1506 are presented above the HIPD 1542. In particular, the HIPD 1542 and the AR device 1528 operate in conjunction to determine a location for presenting the avatar 1504 and the digital representation of the contact 1506. In some embodiments, information can be presented within a predetermined distance from the HIPD 1542 (e.g., within five meters). For example, as shown in the first AR system 1500a, virtual object 1508 is presented on the desk some distance from the HIPD 1542. Similar to the above example, the HIPD 1542 and the AR device 1528 can operate in conjunction to determine a location for presenting the virtual object 1508. Alternatively, in some embodiments, presentation of information is not bound by the HIPD 1542. More specifically, the avatar 1504, the digital representation of the contact 1506, and the virtual object 1508 do not have to be presented within a predetermined distance of the HIPD 1542. While an AR device 1528 is described working with an HIPD, an MR headset can be interacted with in the same way as the AR device 1528.

User inputs provided at the wrist-wearable device 1526, the AR device 1528, and/or the HIPD 1542 are coordinated such that the user can use any device to initiate, continue, and/or complete an operation. For example, the user 1502 can provide a user input to the AR device 1528 to cause the AR device 1528 to present the virtual object 1508 and, while the virtual object 1508 is presented by the AR device 1528, the user 1502 can provide one or more hand gestures via the wrist-wearable device 1526 to interact and/or manipulate the virtual object 1508. While an AR device 1528 is described working with a wrist-wearable device 1526, an MR headset can be interacted with in the same way as the AR device 1528.

Integration of Artificial Intelligence with XR Systems

FIG. 6A illustrates an interaction in which an artificially intelligent virtual assistant can assist in requests made by a user 1502. The A1 virtual assistant can be used to complete open-ended requests made through natural language inputs by a user 1502. For example, in FIG. 15A the user 1502 makes an audible request 1544 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 15A also illustrates an example neural network 1552 used in Artificial Intelligence applications. Uses of Artificial Intelligence (AI) are varied and encompass many different aspects of the devices and systems described herein. AI capabilities cover a diverse range of applications and deepen interactions between the user 1502 and user devices (e.g., the AR device 1528, an MR device 1532, the HIPD 1542, the wrist-wearable device 1526). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 1502 can interact with an AI model through natural language inputs captured by a voice sensor, text inputs, or any other input modality that accepts natural language and/or a corresponding voice sensor module. In another instance, input is provided by tracking the eye gaze of a user 1502 via a gaze tracker module. Additionally, the AI model can also receive inputs beyond those supplied by a user 1502. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 1528) or from multiple devices that are in communication with each other (e.g., a system that includes at least two of an AR device 1528, an MR device 1532, the HIPD 1542, the wrist-wearable device 1526, etc.). The AI model can also access additional information (e.g., one or more servers 1530, the computers 1540, the mobile devices 1550, and/or other electronic devices) via a network 1525.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 1528, an MR device 1532, the HIPD 1542, the wrist-wearable device 1526) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 1528, an MR device 1532, the HIPD 1542, the wrist-wearable device 1526), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 1542), haptic feedback can provide information to the user 1502. An AI model can also use the inputs described above to determine the appropriate modality and device(s) to present content to the user (e.g., a user walking on a busy road can be presented with an audio output instead of a visual output to avoid distracting the user 1502).

### Example Augmented Reality Interaction

FIG. 15B shows the user 1502 wearing the wrist-wearable device 1526 and the AR device 1528 and holding the HIPD 1542. In the second AR system 1500b, the wrist-wearable device 1526, the AR device 1528, and/or the HIPD 1542 are used to receive and/or provide one or more messages to a contact of the user 1502. In particular, the wrist-wearable device 1526, the AR device 1528, and/or the HIPD 1542 detect and coordinate one or more user inputs to initiate a messaging application and prepare a response to a received message via the messaging application.

In some embodiments, the user 1502 initiates, via a user input, an application on the wrist-wearable device 1526, the AR device 1528, and/or the HIPD 1542 that causes the application to initiate on at least one device. For example, in the second AR system 1500b the user 1502 performs a hand gesture associated with a command for initiating a messaging application (represented by messaging user interface 1512); the wrist-wearable device 1526 detects the hand gesture; and, based on a determination that the user 1502 is wearing the AR device 1528, causes the AR device 1528 to present a messaging user interface 1512 of the messaging application. The AR device 1528 can present the messaging user interface 1512 to the user 1502 via its display (e.g., as shown by user 1502's field of view 1510). In some embodiments, the application is initiated and can be run on the device (e.g., the wrist-wearable device 1526, the AR device 1528, and/or the HIPD 1542) that detects the user input to initiate the application, and the device provides another device operational data to cause the presentation of the messaging application. For example, the wrist-wearable device 1526 can detect the user input to initiate a messaging application, initiate and run the messaging application, and provide operational data to the AR device 1528 and/or the HIPD 1542 to cause presentation of the messaging application. Alternatively, the application can be initiated and run at a device other than the device that detected the user input. For example, the wrist-wearable device 1526 can detect the hand gesture associated with initiating the messaging application and cause the HIPD 1542 to run the messaging application and coordinate the presentation of the messaging application.

Further, the user 1502 can provide a user input provided at the wrist-wearable device 1526, the AR device 1528, and/or the HIPD 1542 to continue and/or complete an operation initiated at another device. For example, after initiating the messaging application via the wrist-wearable device 1526 and while the AR device 1528 presents the messaging user interface 1512, the user 1502 can provide an input at the HIPD 1542 to prepare a response (e.g., shown by the swipe gesture performed on the HIPD 1542). The user 1502's gestures performed on the HIPD 1542 can be provided and/or displayed on another device. For example, the user 1502's swipe gestures performed on the HIPD 1542 are displayed on a virtual keyboard of the messaging user interface 1512 displayed by the AR device 1528.

In some embodiments, the wrist-wearable device 1526, the AR device 1528, the HIPD 1542, and/or other communicatively coupled devices can present one or more notifications to the user 1502. The notification can be an indication of a new message, an incoming call, an application update, a status update, etc. The user 1502 can select the notification via the wrist-wearable device 1526, the AR device 1528, or the HIPD 1542 and cause presentation of an application or operation associated with the notification on at least one device. For example, the user 1502 can receive a notification that a message was received at the wrist-wearable device 1526, the AR device 1528, the HIPD 1542, and/or other communicatively coupled device and provide a user input at the wrist-wearable device 1526, the AR device 1528, and/or the HIPD 1542 to review the notification, and the device detecting the user input can cause an application associated with the notification to be initiated and/or presented at the wrist-wearable device 1526, the AR device 1528, and/or the HIPD 1542.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 1528 can present to the user 1502 game application data and the HIPD 1542 can use a controller to provide inputs to the game. Similarly, the user 1502 can use the wrist-wearable device 1526 to initiate a camera of the AR device 1528, and the user can use the wrist-wearable device 1526, the AR device 1528, and/or the HIPD 1542 to manipulate the image capture (e.g., zoom in or out, apply filters) and capture image data.

While an AR device 1528 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 15C-1 and 15C-2, the user 1502 is shown wearing the wrist-wearable device 1526 and an MR device 1532 (e.g., a device capable of providing either an entirely VR experience or an MR experience that displays object(s) from a physical environment at a display of the device) and holding the HIPD 1542. In the third AR system 1500c, the wrist-wearable device 1526, the MR device 1532, and/or the HIPD 1542 are used to interact within an MR environment, such as a VR game or other MR/VR application. While the MR device 1532 presents a representation of a VR game (e.g., first MR game environment 1520) to the user 1502, the wrist-wearable device 1526, the MR device 1532, and/or the HIPD 1542 detect and coordinate one or more user inputs to allow the user 1502 to interact with the VR game.

In some embodiments, the user 1502 can provide a user input via the wrist-wearable device 1526, the MR device 1532, and/or the HIPD 1542 that causes an action in a corresponding MR environment. For example, the user 1502 in the third MR system 1500c (shown in FIG. 15C-1) raises the HIPD 1542 to prepare for a swing in the first MR game environment 1520. The MR device 1532, responsive to the user 1502 raising the HIPD 1542, causes the MR representation of the user 1522 to perform a similar action (e.g., raise a virtual object, such as a virtual sword 1524). In some embodiments, each device uses respective sensor data and/or image data to detect the user input and provide an accurate representation of the user 1502's motion. For example, image sensors (e.g., SLAM cameras or other cameras) of the HIPD 1542 can be used to detect a position of the HIPD 1542 relative to the user 1502's body such that the virtual object can be positioned appropriately within the first MR game environment 1520; sensor data from the wrist-wearable device 1526 can be used to detect a velocity at which the user 1502 raises the HIPD 1542 such that the MR representation of the user 1522 and the virtual sword 1524 are synchronized with the user 1502's movements; and image sensors of the MR device 1532 can be used to represent the user 1502's body, boundary conditions, or real-world objects within the first MR game environment 1520.

In FIG. 15C-2, the user 1502 performs a downward swing while holding the HIPD 1542. The user 1502's downward swing is detected by the wrist-wearable device 1526, the MR device 1532, and/or the HIPD 1542 and a corresponding action is performed in the first MR game environment 1520. In some embodiments, the data captured by each device is used to improve the user's experience within the MR environment. For example, sensor data of the wrist-wearable device 1526 can be used to determine a speed and/or force at which the downward swing is performed and image sensors of the HIPD 1542 and/or the MR device 1532 can be used to determine a location of the swing and how it should be represented in the first MR game environment 1520, which, in turn, can be used as inputs for the MR environment (e.g., game mechanics, which can use detected speed, force, locations, and/or aspects of the user 1502's actions to classify a user's inputs (e.g., user performs a light strike, hard strike, critical strike, glancing strike, miss) or calculate an output (e.g., amount of damage)).

FIG. 15C-2 further illustrates that a portion of the physical environment is reconstructed and displayed at a display of the MR device 1532 while the MR game environment 1520 is being displayed. In this instance, a reconstruction of the physical environment 1546 is displayed in place of a portion of the MR game environment 1520 when object(s) in the physical environment are potentially in the path of the user (e.g., a collision with the user and an object in the physical environment are likely). Thus, this example MR game environment 1520 includes (i) an immersive VR portion 1548 (e.g., an environment that does not have a corollary counterpart in a nearby physical environment) and (ii) a reconstruction of the physical environment 1546 (e.g., table 1550 and cup 1552). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 1526, the MR device 1532, and/or the HIPD 1542 are described as detecting user inputs, in some embodiments, user inputs are detected at a single device (with the single device being responsible for distributing signals to the other devices for performing the user input). For example, the HIPD 1542 can operate an application for generating the first MR game environment 1520 and provide the MR device 1532 with corresponding data for causing the presentation of the first MR game environment 1520, as well as detect the user 1502's movements (while holding the HIPD 1542) to cause the performance of corresponding actions within the first MR game environment 1520. Additionally or alternatively, in some embodiments, operational data (e.g., sensor data, image data, application data, device data, and/or other data) of one or more devices is provided to a single device (e.g., the HIPD 1542) to process the operational data and cause respective devices to perform an action associated with processed operational data.

In some embodiments, the user 1502 can wear a wrist-wearable device 1526, wear an MR device 1532, wear smart textile-based garments 1538 (e.g., wearable haptic gloves), and/or hold an HIPD 1542 device. In this embodiment, the wrist-wearable device 1526, the MR device 1532, and/or the smart textile-based garments 1538 are used to interact within an MR environment (e.g., any AR or MR system described above in reference to FIGS. 15A-15B). While the MR device 1532 presents a representation of an MR game (e.g., second MR game environment 1520) to the user 1502, the wrist-wearable device 1526, the MR device 1532, and/or the smart textile-based garments 1538 detect and coordinate one or more user inputs to allow the user 1502 to interact with the MR environment.

In some embodiments, the user 1502 can provide a user input via the wrist-wearable device 1526, an HIPD 1542, the MR device 1532, and/or the smart textile-based garments 1538 that causes an action in a corresponding MR environment. In some embodiments, each device uses respective sensor data and/or image data to detect the user input and provide an accurate representation of the user 1502's motion. While four different input devices are shown (e.g., a wrist-wearable device 1526, an MR device 1532, an HIPD 1542, and a smart textile-based garment 1538) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 1538) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 1538 can be used in conjunction with an MR device and/or an HIPD 1542.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 15A-15C-2 provided above are intended to augment the description provided in reference to FIGS. 1-14. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method, comprising:
displaying, at an augmented-reality (AR) display of an AR headset, a map augment that includes a first set of AR landmarks, wherein:
the AR headset has a first orientation in a physical environment, and
the first set of AR landmarks are configured to be presented to a wearer of the AR headset such that the first set of AR landmarks overlays a corresponding first set of physical landmarks of the physical environment seen through the AR display; and
in response to detecting a change in orientation of the AR headset to a second orientation in the physical environment different from the first orientation, displaying the map augment to include a second set of AR landmarks, wherein:
the second set of AR landmarks are configured to be presented to the wearer of the AR headset such that the second set of AR landmarks overlays a corresponding second set physical landmarks of the physical environment seen through the AR display, and
the second set of AR landmarks is different from the first set of AR landmarks.

2. The method of claim 1, wherein the map augment includes an AR route augment that is configured to be presented to a wearer of the AR headset such that the AR route augment overlays a corresponding route of the physical environment seen through the AR display.

3. The method of claim 2, wherein the AR route augment is walking route guidance or driving route guidance.

4. The method of claim 1, wherein the first set of AR landmarks are visually different than the corresponding first set of physical landmarks in the physical environment.

5. The method of claim 1, wherein the AR display corresponds to a single eye of a user.

6. The method of claim 1, further comprising:
receiving information from an application of the AR headset;
in accordance with a determination that the information is associated with a location, displaying an augment for invoking an AR navigation application of the AR headset to navigate the location;
receiving an interaction at the augment; and
in response to receiving the interaction, displaying at an AR display of an augmented-reality an AR interface that includes:
a route overview augment that shows a route to the location; and
an augment for initiating route guidance.

7. The method of claim 6, further comprising:
receiving an interaction at the AR augment for initiating route guidance; and
in response to receiving the interaction at the AR augment for initiating route guidance, displaying a perspective route AR augment for providing turn-by-turn navigation to the location.

8. The method of claim 6, wherein the application is different from the AR navigation application.

9. A non-transitory computer-readable storage medium including instructions that, when executed by a computing device, cause the computing device to:
display, at an AR display of an AR headset, a map augment that includes a first set of AR landmarks, wherein:
the AR headset has a first orientation in a physical environment, and
the first set of AR landmarks are configured to be presented to a wearer of the AR headset such that the first set of AR landmarks overlays a corresponding first set of physical landmarks of the physical environment seen through the AR display; and
in response to detecting a change in orientation of the AR headset to a second orientation in the physical environment different from the first orientation, display the map augment to include a second set of AR landmarks, wherein:
the second set of AR landmarks are configured to be presented to the wearer of the AR headset such that the second set of AR landmarks overlays a corresponding second set physical landmarks of the physical environment seen through the AR display, and
the second set of AR landmarks is different from the first set of AR landmarks.

10. The non-transitory computer-readable storage medium of claim 9, wherein the map augment includes an AR route augment that is configured to be presented to a wearer of the AR headset such that the AR route augment overlays a corresponding route of the physical environment seen through the AR display.

11. The non-transitory computer-readable storage medium of claim 10, wherein the AR route augment is walking route guidance or driving route guidance.

12. The non-transitory computer-readable storage medium of claim 9, wherein the first set of AR landmarks are visually different than the corresponding first set of physical landmarks in the physical environment.

13. The non-transitory computer-readable storage medium of claim 9, wherein the AR display corresponds to a single eye of a user.

14. The non-transitory computer-readable storage medium of claim 9, further comprising instructions for:
receiving information from an application of the AR headset;
in accordance with a determination that the information is associated with a location, displaying an augment for invoking an AR navigation application of the AR headset to navigate the location;
receiving an interaction at the augment; and
in response to receiving the interaction, displaying at an AR display of an augmented-reality an AR interface that includes:
a route overview augment that shows a route to the location; and
an augment for initiating route guidance.

15. An electronic device, comprising:
one or more programs, wherein the one or more programs are stored in memory and configured to be executed by one or more processors, the one or more programs including instructions for:
displaying, at an augmented-reality (AR) display of an AR headset, a map augment that includes a first set of AR landmarks, wherein:
the AR headset has a first orientation in a physical environment, and
the first set of AR landmarks are configured to be presented to a wearer of the AR headset such that the first set of AR landmarks overlays a corresponding first set of physical landmarks of the physical environment seen through the AR display; and
in response to detecting a change in orientation of the AR headset to a second orientation in the physical environment different from the first orientation, displaying the map augment to include a second set of AR landmarks, wherein:
the second set of AR landmarks are configured to be presented to the wearer of the AR headset such that the second set of AR landmarks overlays a corresponding second set physical landmarks of the physical environment seen through the AR display, and
the second set of AR landmarks is different from the first set of AR landmarks.

16. The electronic device of claim 15, wherein the map augment includes an AR route augment that is configured to be presented to a wearer of the AR headset such that the AR route augment overlays a corresponding route of the physical environment seen through the AR display.

17. The electronic device of claim 16, wherein the AR route augment is walking route guidance or driving route guidance.

18. The electronic device of claim 15, wherein the first set of AR landmarks are visually different than the corresponding first set of physical landmarks in the physical environment.

19. The electronic device of claim 15, wherein the AR display corresponds to a single eye of a user.

20. The electronic device of claim 15, wherein the one or more programs further comprise instructions for:
receiving information from an application of the AR headset;
in accordance with a determination that the information is associated with a location, displaying an augment for invoking an AR navigation application of the AR headset to navigate the location;
receiving an interaction at the augment; and
in response to receiving the interaction, displaying at an AR display of an augmented-reality an AR interface that includes:
a route overview augment that shows a route to the location; and
an augment for initiating route guidance.
